(19) United States
(12) Patent Application Publication
(10) Pub. No.: US 2025/0348041 A1
(43) Pub. Date: Nov. 13, 2025

(54) ANNULAR OSCILLATING MASS AND TIMEPIECE COMPRISING SUCH AN OSCILLATING MASS

(71) Applicant: Montres Breguet S.A., L'Abbaye (CH)

(72) Inventors: Laurent GUILLAUME, Le Sentier (CH); Alexandre GUIGNARD, Labergement Sainte Marie (FR); Nicolas HADEY, Le Sentier (CH)

(73) Assignee: Montres Breguet S.A., L'Abbaye (CH)

(21) Appl. No.: 19/171,616

(22) Filed: Apr. 7, 2025

(30) Foreign Application Priority Data
May 8, 2024 (EP) 24174944.9

(51) Int. Cl. G04B 5/18; G04B 5/16

(52) U.S. Cl. CPC G04B 5/18; G04B 5/16

(57) ABSTRACT

An oscillating mass (1) for a self-winding timepiece including a carrier bow (2) including a first transmission part (20) provided with coaxial toothing (21) to drive the winding of the timepiece and a second supporting part (22), and including a heavy sector (3) or attached to the second supporting part of the carrier bow (2). The heavy sector (3) is attached to the carrier bow at several points via blom studs (4) with an uneven surface to form a reservoir for holding glue.

### CROSS REFERENCE TO RELATED APPLICATIONS

This application is claiming priority based on European Patent Application No. 24174944.9 filed on May 8, 2024.

### TECHNICAL FIELD OF THE INVENTION

The invention relates to an annular oscillating mass comprising a carrier bow comprising an annular transmission part provided with toothing coaxial to the bow, and a heavy sector attached to the carrier bow. The present invention also relates to a horology movement and a self-winding timepiece respectively comprising the annular oscillating mass of the invention.

### TECHNOLOGICAL BACKGROUND

Automatic watches equipped with an annular oscillating mass are common. This oscillating mass is housed in a circular recess arranged about the movement inside the watchcase. Rolling runners are also arranged at the edge of the recess to support and guide the oscillating mass, so that it is free to rotate within the recess. The carrier bow can, for example, have internal toothing, whereby the rotational movements of the oscillating mass are mechanically transferred to the barrel of the movement. The oscillating mass thus ensures the automatic winding of the barrel spring.

One problem encountered with such oscillating masses is that they are easily deformed during their assembly, especially when the assembly of the elements that make up the annular oscillating mass is carried out using driven pins or blom studs. Such deformations can impair the smooth functioning of the oscillating mass and the perceived quality of the piece.

Another problem with such oscillating masses is that the pins or blom studs can be dislodged by shocks and cause damage to other parts of the movement.

### SUMMARY OF THE INVENTION

The invention aims in particular to remedy the various drawbacks of the prior art.

The invention aims to provide an annular oscillating mass without generating stresses that could impair the geometry of the toothed bow, while providing improved shock resistance.

To this end, the present invention relates to an oscillating mass for a self-winding timepiece comprising a carrier bow comprising a first transmission part provided with coaxial toothing to drive the winding of the timepiece and a second supporting part, and comprising a heavy sector attached to the second annular supporting part of the carrier bow.

According to the invention, the heavy sector is fastened to the carrier bow at several points via blom studs with an uneven surface to form a reservoir for holding glue.

According to other advantageous variants of the invention:
the carrier bow has a shoulder between the first annular part and the second annular part of the carrier bow, the first annular part and the second annular part extending in different parallel planes;
the heavy sector has a shoulder that is complementary to the shoulder of the carrier bow;
the second annular part and the heavy sector respectively comprise openings and holes to accommodate the blom studs;
the blom studs have a head and a body, with the uneven surface extending from the foot to the head over part of the length of the blom stud;
the body of each blom stud (4) has a chamfer;
the holes have a diameter smaller than the diameter of the foot of the blom stud;
the heads of the blom studs are flush with the surface of the second annular supporting part.

The invention also relates to a horology movement and a timepiece comprising an oscillating mass in accordance with the invention.

The invention also relates to a method of assembling an oscillating mass in accordance with the invention, the method comprising the following steps:
providing a carrier bow and a heavy sector;
machining the carrier bow and the heavy sector to make openings and holes;
depositing a drop of glue in each of the holes in the heavy sector;
inserting blom studs into the openings in the carrier bow and then driving them into the holes to form the oscillating mass;
baking the oscillating mass in the oven to polymerise the glue.

### BRIEF DESCRIPTION OF THE FIGURES

Other features and advantages of the invention will become apparent from the following detailed description, given by way of non-limiting example, with reference to the attached drawings in which:

FIG. 1 is a view from underneath of an oscillating mass according to the invention;

FIG. 2 is a perspective top view of an oscillating mass according to the invention;

FIG. 3a is an exploded view of an oscillating mass according to the invention;

FIG. 3b illustrates a detailed view of a blom stud of the oscillating mass according to the invention;

FIG. 4 is a cross-sectional view along line V-V in FIG. 1.

### DETAILED DESCRIPTION OF THE INVENTION

FIG. 2 is a perspective view of an annular oscillating mass 1 in accordance with the invention.

The invention is described in the case of an annular oscillating mass and is also suitable for a conventional oscillating mass in the shape of a half-disc.

The oscillating mass 1 shown comprises a carrier bow 2 and a heavy sector 3. In accordance with the invention, the carrier bow comprises a first annular transmission part 20 provided with toothing 21 to drive the winding of the timepiece and a second annular supporting part 22. As shown in FIG. 2, the heavy sector 3 is carried by and integral with the second annular part 22, while the first annular transmission part 20 has concentric inner toothing 21.

The heavy sector is made of a material with a high density, higher than the materials generally used for an oscillating mass, such as gold or tungsten.

The carrier bow 2 has a shoulder 23 between the first annular part 20 and the second annular part 22 of the carrier bow, the first annular part and the second annular part being in different parallel planes. The heavy sector 3 also has a shoulder 30 with a complementary shape to the shoulder 23 of the annular part, the heavy sector 3 thus having a first cylindrical portion 31 in contact with the second annular part 22 and a second cylindrical portion 32 resting on the toothing 21. Advantageously, there is a space between the toothing 21 and the second cylindrical portion 32 to compensate for the assembly clearances when the heavy sector is fastened to the carrier bow.

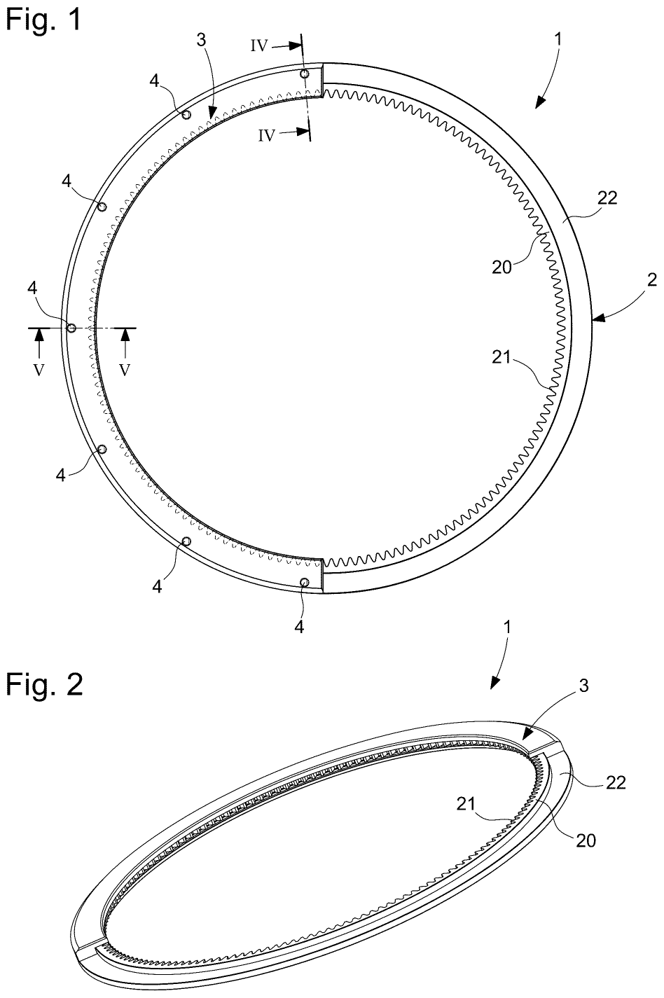

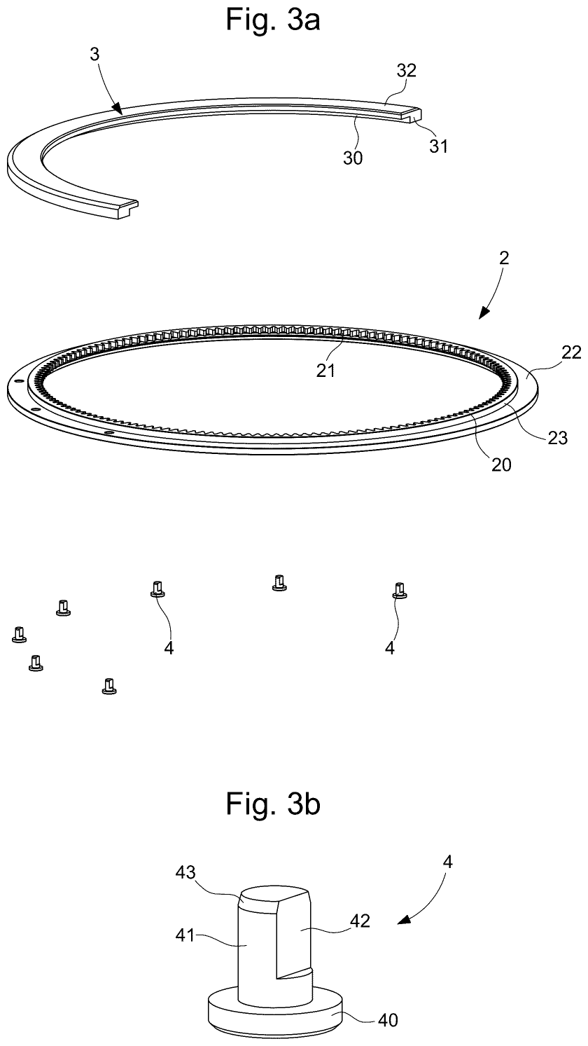

Referring to FIGS. 1 and 3, it can be seen that the heavy sector 3 is joined to the second annular supporting part 22 with blom studs 4. These blom studs 4 have a head 40 and a body 41 comprising an uneven surface 42 to form a reservoir 5 for holding glue when the batches are assembled.

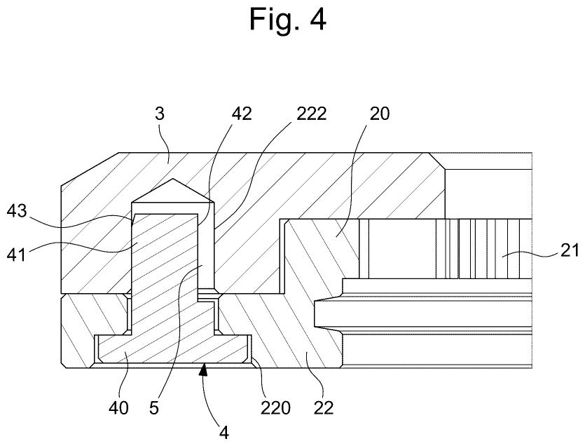

These blom studs 4 are arranged to be driven into openings 220 and holes 222 respectively machined in the second annular part 22 and in the heavy sector 3. As can be seen in FIG. 4, the opening 220 has a first section with a diameter corresponding to the diameter of the head 40 of the blom stud 4, and a second section with a diameter corresponding to the diameter of the body 41 of the blom stud 4, the second section having a diameter smaller than the diameter of the first section. Such an arrangement allows the head 40 of the blom stud 4 to be flush with the surface of the second annular part 22.

The heavy sector 3 has holes 222, preferably blind holes, with a diameter smaller than the diameter of the body of the blom studs 4 for press-fitting or driving in. It can be seen in FIGS. 3b and 4 that body 41 of blom stud 4 has an uneven surface 42 extending from the bottom of body 41 towards the head 40 over part of the height of the body. Such an arrangement enables a reservoir 5 to be formed for the glue when the three elements are assembled, namely the carrier bow 2, the heavy sector 3 and the blom stud 4. The glue thus provides a more reliable overall assembly while reducing the stresses during assembly.

Another advantage of such an uneven surface is that it makes it easier to drive the blom studs in, as the uneven surface forms a gap and prevents the blom stud from causing a piston effect when it is driven in. The piston effect causes a deformation of the heavy sector 3 due to the air trapped in the hole 222 by the blom stud 4 and prevents the blom stud 4 from being driven all the way into the hole.

It can also be seen in FIG. 4 that the blom studs 4 have a chamfer 43 on the free end of the body 42 to facilitate the insertion of the blom studs 4 into the holes 222.

The invention also relates to a method of assembling an oscillating mass as described above.

The method of assembling the oscillating mass comprises the following steps:
providing a carrier bow 2 and a heavy sector 3;
machining the carrier bow and the heavy sector to make openings 220 and holes 222;
depositing a drop of glue in each of the holes 222 in the heavy sector;
inserting blom studs 4 into the openings 220 in the carrier bow 2 and then driving them into the holes 222 to form the oscillating mass 1;
once the mass has been assembled, baking it in the oven to cure the glue.

The oscillating mass according to the invention is meant to be mounted in a horology movement for an automatic watch and ensure the winding of the movement. Such a watch conventionally comprises an energy accumulator, often a barrel, designed to cooperate with the oscillating mass to ensure this function. The oscillating mass thus supplies energy to the accumulator by winding up its spring. The energy accumulator is used to power a time base of the movement, which in turn drives the train.

1. An oscillating mass (1) for a self-winding timepiece comprising a carrier bow (2) comprising a first transmission part (20) provided with coaxial toothing (21) to drive the winding of the timepiece and a second supporting part (22), and comprising a heavy sector (3) attached to the second supporting part (22) of the carrier bow (2), wherein the heavy sector (3) is attached to the carrier bow (2) at several points via blom studs (4) with an uneven surface (42) to form a reservoir (5) for holding glue.

2. The oscillating mass (1) according to claim 1, wherein the carrier bow (2) has a shoulder (23) between the first annular part (20) and the second annular part (22) of the carrier bow (2), the first annular part and the second annular part extending in different parallel planes.

3. The oscillating mass (1) according to claim 1, wherein the heavy sector has a shoulder (30) that is complementary to the shoulder (23) of the carrier bow (2).

4. The oscillating mass (1) according to claim 1, wherein the second part (22) and the heavy sector (3) respectively comprise openings (220) and holes (222) to accommodate the blom studs (4).

5. The oscillating mass (1) according to claim 1, wherein the blom studs (4) have a head (40) and a body (41), the uneven surface (42) extending from the body (41) towards the head (40) over part of the length of the body of the blom stud.

6. The oscillating mass (1) according to claim 5, wherein the body (41) of each blom stud (4) has a chamfer (43).

7. The oscillating mass (1) according to claim 1, wherein the holes (222) have a diameter smaller than the diameter of the foot of the blom stud.

8. The oscillating mass (100) according to claim 1, wherein the head (40) of the blom studs is flush with the surface of the second annular supporting part (22).

9. A horology movement comprising an oscillating mass (1) according to claim 1.

10. A timepiece comprising the horology movement according to claim 9.

11. A method of assembling an oscillating mass (1) according to claim 1, comprising the following steps:
providing a carrier bow (2) and a heavy sector (3);
machining the carrier bow and the heavy sector to make openings (220) and holes (222);
depositing a drop of glue in each of the holes (222) in the heavy sector;
inserting blom studs (4) into the openings (220) in the carrier bow (2) and then driving them into the holes (222) to form the oscillating mass (1);
baking the oscillating mass (1) in the oven to polymerise the glue.
